(19) United States
(12) Patent Application Publication
(10) Pub. No.: US 2026/0087590 A1
(43) Pub. Date: Mar. 26, 2026

(54) IMAGE PROCESSING METHOD AND DISPLAY DEVICE USING THE SAME

(71) Applicant: Coretronic Corporation, Hsin-Chu (TW)

(72) Inventors: Tsung-Lung Ho, Hsin-Chu (TW); Te-Sung Su, Hsin-Chu (TW)

(73) Assignee: Coretronic Corporation, Hsin-Chu (TW)

(21) Appl. No.: 19/340,833

(22) Filed: Sep. 25, 2025

Related U.S. Application Data
(60) Provisional application No. 63/699,161, filed on Sep. 26, 2024.

(30) Foreign Application Priority Data
Dec. 11, 2024 (CN) 202411816637.8

(51) Int. Cl. G06T 5/20; G06T 5/50; G06T 5/70; G06T 5/94; G06T 11/00

(52) U.S. Cl. CPC G06T 5/20; G06T 5/50; G06T 5/70; G06T 5/94; G06T 11/10; G06T 2207/20192; G06T 2207/20216

(57) ABSTRACT

Disclosed are an image processing method and a display device using the same. The method includes: performing a first color space conversion on an original image to generate a reference image corresponding to a first color space; detecting image regions with high-frequency signals to generate a detection result; performing operations on the detection result to generate a first computation result; evaluating the detection result and the first computation result to select a reference gain value; performing operations on the detection result to generate a second computation result; selecting at least one of brightness values of a first pixel of a first fused image and a second pixel of a second fused image to generate a brightness value of a pixel of a third fused image; and performing a second color space conversion on the third fused image to generate an output image corresponding to a second color space.

### CROSS-REFERENCE TO RELATED APPLICATION

This application claims the priority benefit of U.S. provisional applications Ser. No. 63/699,161, filed on Sep. 26, 2024 and China application serial no. 202411816637.8, filed on Dec. 11, 2024. The entirety of the above-mentioned patent application is hereby incorporated by reference herein and made a part of this specification.

### BACKGROUND

### Technical Field

The present disclosure relates to an image processing technique, and particularly relates to an image processing method and a display device applying the image processing method.

### Description of Related Art

Numerous image processing techniques are currently available to enhance the clarity of projector images, such as the utilization of high-pass filters (also known as sharpening filters) to increase image sharpness. Although such filters may render images clearer, they also produce an adverse effect known as the ringing effect.

Please refer to FIG. 1, which shows a visual effect diagram of a display processing an image with a high-pass filter. In FIG. 1, an image 110 is the result generated by processing an image 100 with a high-pass filter.

From the difference between the image 100 and the image 110, it can be seen that after processing with the high-pass filter, the edge portions (for example, the hair accessory in the dashed box) become whiter, causing a ringing effect at the edges, making the overall image appear overly sharp and unnatural, thereby affecting the quality of the image and the viewer's viewing experience.

Therefore, for those skilled in the art, how to design a technical solution that enables an image to become clearer after passing through the high-pass filter while simultaneously suppressing the ringing effect is indeed an important issue.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

At least one of the technical problems to be solved by the present disclosure is how to design a technical feature that makes the image clearer after passing through the high-pass filter, and suppresses the ringing effect.

To achieve one or part or all of the above purposes or other purposes, an image processing method in an embodiment of the present disclosure includes: performing, by an image pre-processing circuit, a conversion of a first color space on an original image to generate a reference image corresponding to a first color space; detecting, by an edge filter, an image region with a high-frequency signal in a reference image to generate a detection result; performing, by a first fusing circuit, an operation on the detection result based on a preset gain value to generate a first computation result; evaluating, by a gain selection circuit, the detection result and the first computation result to select a reference gain value; performing, by a second fusing circuit, an operation on the detection result based on the reference gain value to generate a second computation result; selecting, by a multiplexer and based on the first computation result and the second computation result, at least one of brightness values of a first pixel of a first fused image and a second pixel of a second fused image to generate a brightness value of a pixel of a third fused image; and performing, by an image post-processing circuit, a conversion of a second color space on the third fused image to generate an output image corresponding to a second color space.

In an embodiment, the edge filter includes at least one of a high-pass filter, a mean filter, a median filter, a Gaussian filter, a Laplacian filter, and a Sobel filter.

In an embodiment, the image region with the high-frequency signal is an image region where the change in brightness value in the reference image is greater than a preset value.

In an embodiment, the method further includes: detecting, by the edge filter, brightness values of reference pixels in the reference image to obtain positions of the reference pixels corresponding to the image region with the high-frequency signal to generate the detection result.

In an embodiment, the method further includes: magnifying, by the first fusing circuit and according to the preset gain value, a brightness value of the reference pixel with high-frequency signal in the detection result by a magnification factor to generate a first fused image; and generating, by the first fusing circuit, a first computation result according to the first fused image.

In an embodiment, the method further includes: determining, by the gain selection circuit, whether the brightness value of at least one of the first pixels in the first fused image of the first computation result is greater than a first threshold.

In an embodiment, the method further includes: in response to determining that the brightness value of a first specific pixel is greater than the first threshold, selecting, by the gain selection circuit, a first gain value as a reference gain value corresponding to the first specific pixel, wherein the first specific pixel is at least one of the first pixels.

In an embodiment, the method further includes: in response to determining that the brightness value of the first specific pixel is not greater than the first threshold, selecting, by the gain selection circuit, a second gain value as the reference gain value corresponding to the first specific pixel, wherein the second gain value is greater than the first gain value.

In an embodiment, the method further includes: magnifying, by the second fusing circuit and according to the reference gain value, the brightness value of the reference pixel with high-frequency signal in the detection result by a magnification factor to generate a second fused image; and generating, by the second fusing circuit, the second computation result according to the second fused image.

In an embodiment, the method further includes: determining, by the multiplexer, whether the brightness value of the first pixel of the first fused image is greater than a preset threshold.

In an embodiment, the method further includes, in response to determining that the brightness value of the first pixel is greater than the preset threshold, selecting, by the multiplexer, a brightness value of the second pixel of the second fused image as a brightness value of a third pixel of the third fused image.

In an embodiment, the method further includes, in response to determining that the brightness value of the first pixel is not greater than the preset threshold, selecting, by the multiplexer, the brightness value of the first pixel of the first fused image as a brightness value of the third pixel of the third fused image.

In addition, a display device in an embodiment of this disclosure includes an image processing device and an imaging device. The image processing device includes an image pre-processing circuit, an edge filter, a first fusing circuit, a gain selection circuit, a second fusing circuit, a multiplexer, and an image post-processing circuit. The image pre-processing circuit is configured to implement a conversion of a first color space on the original image to generate a reference image corresponding to the first color space. The edge filter is electrically connected to the image pre-processing circuit and configured to detect the image region with the high-frequency signal in the reference image to generate a detection result. The first fusing circuit is electrically connected to the edge filter and configured to implement the operation on the detection result with a preset gain value to generate a first computation result. The gain selection circuit is electrically connected to the edge filter and configured to evaluate the detection result and the first computation result to select a reference gain value. The second fusing circuit is electrically connected to the gain selection circuit and configured to implement the operation on the detection result according to the reference gain value to generate a second computation result. The multiplexer is electrically connected to the first fusing circuit and the second fusing circuit and configured to select at least one of the brightness values of the first pixel of the first fused image and the second pixel of the second fused image according to the first computation result and the second computation result to generate the brightness value of the pixel of the third fused image. The image post-processing circuit is electrically connected to the multiplexer and configured to implement a conversion of the second color space on the third fused image to generate an output image corresponding to the second color space. The imaging device is electrically connected to the image processing device and configured to receive and display the output image.

In an embodiment, the edge filter includes at least one of a high-pass filter, a mean filter, a median filter, a Gaussian filter, a Laplacian filter, and a Sobel filter.

In an embodiment, the image region with the high-frequency signal is an image region where the change in brightness value in the reference image is greater than a preset value.

In an embodiment, the edge filter detect is configured to detect brightness values of reference pixels in the reference image to obtain positions of the reference pixels corresponding to the image region with the high-frequency signal to generate the detection result.

In an embodiment, the first fusing circuit is configured to magnify, according to the preset gain value, the brightness value of the reference pixel with high-frequency signal in the detection result by a magnification factor to generate a first fused image; and the first fusing circuit is configured to generate the first computation result according to the first fused image.

In an embodiment, the gain selection circuit is configured to determine whether the brightness value of at least one of the first pixels in the first fused image of the first computation result is greater than a first threshold.

In an embodiment, in response to determining that the brightness value of a first specific pixel is greater than the first threshold, the gain selection circuit is configured to select a first gain value as a reference gain value corresponding to the first specific pixel, wherein the first specific pixel is at least one of the first pixels.

In an embodiment, in response to determining that the brightness value of the first specific pixel is not greater than the first threshold, the gain selection circuit is configured to select a second gain value as the reference gain value corresponding to the first specific pixel, wherein the second gain value is greater than the first gain value.

In an embodiment, the second fusing circuit is configured to magnify, according to the reference gain value, the brightness value of the reference pixel with high-frequency signal in the detection result by a magnification factor to generate a second fused image; and the second fusing circuit is configured to generate a second computation result according to the second fused image.

In an embodiment, the multiplexer is configured to determine whether the brightness value of the first pixel of the first fused image is greater than a preset threshold.

In an embodiment, in response to determining that the brightness value of the first pixel is greater than the preset threshold, the multiplexer is configured to select a brightness value of the second pixel of the second fused image as a brightness value of a third pixel of the third fused image.

In an embodiment, in response to determining that the brightness value of the first pixel is not greater than the preset threshold, the multiplexer is configured to select the brightness value of the first pixel of the first fused image as the brightness value of the third pixel of the third fused image.

### BRIEF DESCRIPTION OF THE DRAWINGS

FIG. 1 are images illustrating visual effect of processing an image with a high-pass filter.

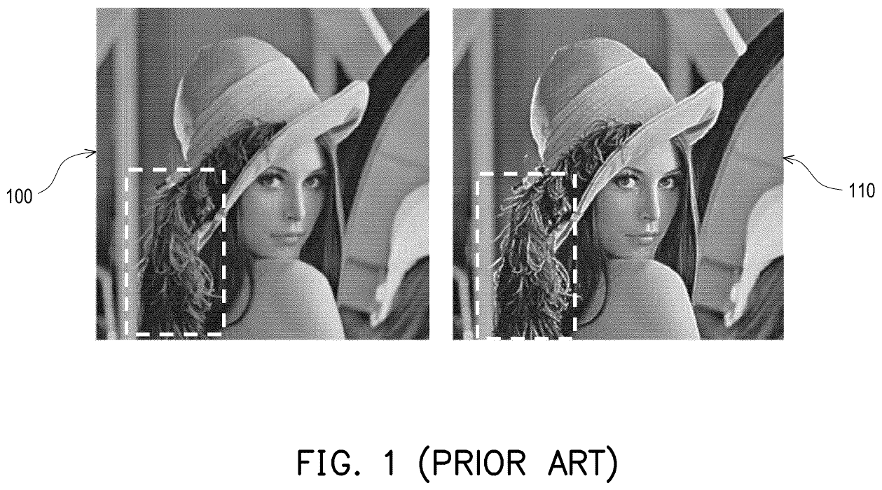

FIG. 2 is a schematic diagram of a display device illustrated according to an embodiment of the present disclosure.

FIG. 3 is a schematic diagram of an image processing device illustrated according to FIG. 2.

FIG. 4 is a flowchart of an image processing method illustrated according to an embodiment of the present disclosure.

FIG. 5 is a schematic diagram of generating a third fused image illustrated according to an embodiment of the present disclosure.

FIG. 6 is a diagram illustrating an image processing effect according to an embodiment of the present disclosure.

FIG. 7 is a diagram illustrating an image processing effect according to an embodiment of the present disclosure.

### DESCRIPTION OF THE EMBODIMENTS

It is to be understood that other embodiments may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. The use of “at least one of . . . and . . .” thereof herein may include “one or more of one or more of the items contained in the list”. For example, the use of “at least one of A and B” thereof herein may include only A, or only B, or A and B. Similarly, the use of “at least one of A, B, and C” thereof herein may include only A, or only B, or only C, or any combination of A, B, and C.

Regarding the aforementioned and other technical contents, features, and effects of the present disclosure, they will be clearly presented in the following detailed description of a preferred embodiment with reference to the accompanying drawings. The directional terms mentioned in the following embodiments, such as: up, down, left, right, front or back, etc., are only referenced to the directions in the accompanying drawings. Therefore, the directional terms used are for description and not for limiting the present disclosure.

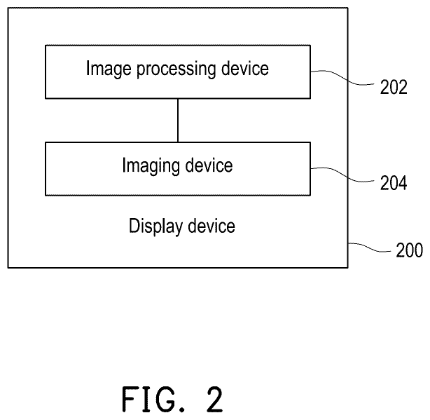

Please refer to FIG. 2, which is a schematic diagram of a display device illustrated according to an embodiment of the present disclosure. In different embodiments, the display device 200 may be, for example, a projector, a display, or other electronic devices that provide display functions, but is not limited thereto. The display device 200 is communicatively connected to an image source through wired or wireless signal transmission, and the image source provides an original image I1 to the display device 200. The image source may be, for example, electronic devices such as a computer, a laptop, a smartphone, or a tablet.

In FIG. 2, the display device 200 includes an image processing device 202 and an imaging device 204. In one example, the image processing device 202 includes at least one image processor and may be used to implement an image processing method. The image processor may be a Microprogrammed Control Unit, a Central Processing Unit (CPU), a Microprocessor, an Application Specific Integrated Circuit (ASIC), a Programmable Logic Device (PLD), a Field Programmable Gate Array (FPGA) chip and circuit from Altera®, or a combination of the above devices, but is not limited thereto.

In addition, the imaging device 204 is electrically connected to the image processing device 202. The imaging device 204 is configured to receive an output image I3 provided by the image processing device 202 and display the output image I3, allowing viewers to see the output image I3. The imaging device 204 may be, for example, an optical engine, a display panel, and/or other optical devices with imaging functions, but is not limited thereto. The optical engine known to those skilled in the art may at least include a light valve and a projection lens. The display panel may be, for example, a liquid crystal display (LCD) panel or a light-emitting diode (LED) panel, but is not limited thereto. Furthermore, an electrical connection represents the relationship of electrical signal transmission between two devices.

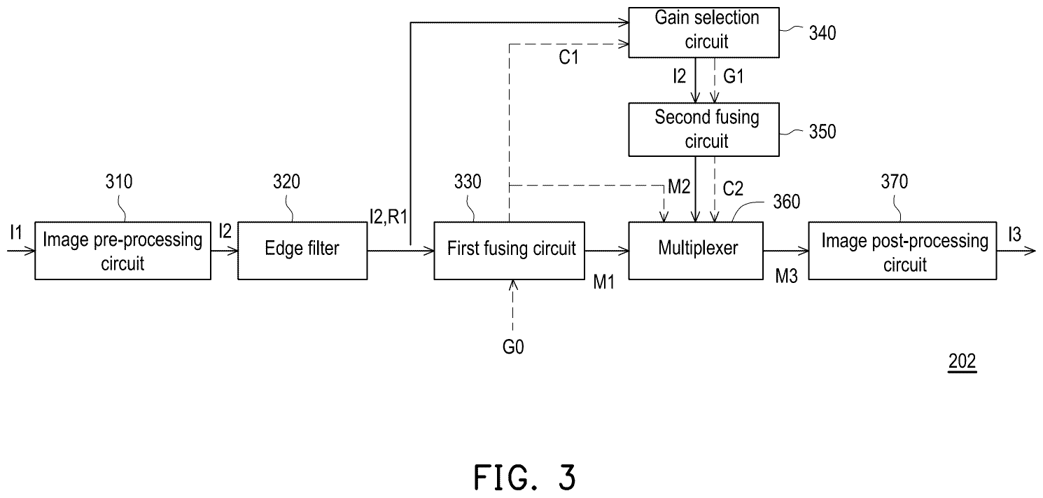

Please refer to FIG. 3, which is a schematic diagram of the image processing device illustrated according to FIG. 2. In FIG. 3, the image processing device 202 at least includes an image pre-processing circuit 310, an edge filter 320, a first fusing circuit 330, a gain selection circuit 340, a second fusing circuit 350, a multiplexer 360, and an image post-processing circuit 370.

As shown in FIG. 3, the edge filter 320 is electrically connected to the image pre-processing circuit 310; the first fusing circuit 330 is electrically connected to the edge filter 320; the gain selection circuit 340 is electrically connected to the edge filter 320; the second fusing circuit 350 is electrically connected to the gain selection circuit 340; the multiplexer 360 is electrically connected to the first fusing circuit 330 and the second fusing circuit 350; and the image post-processing circuit 370 is electrically connected to the multiplexer 360 and the imaging device 204.

In an embodiment of this disclosure, the image processing device 202 and the imaging device 204 of the display device 200 may be configured to implement the image processing method proposed by an embodiment of this disclosure, the details of which are described as follows.

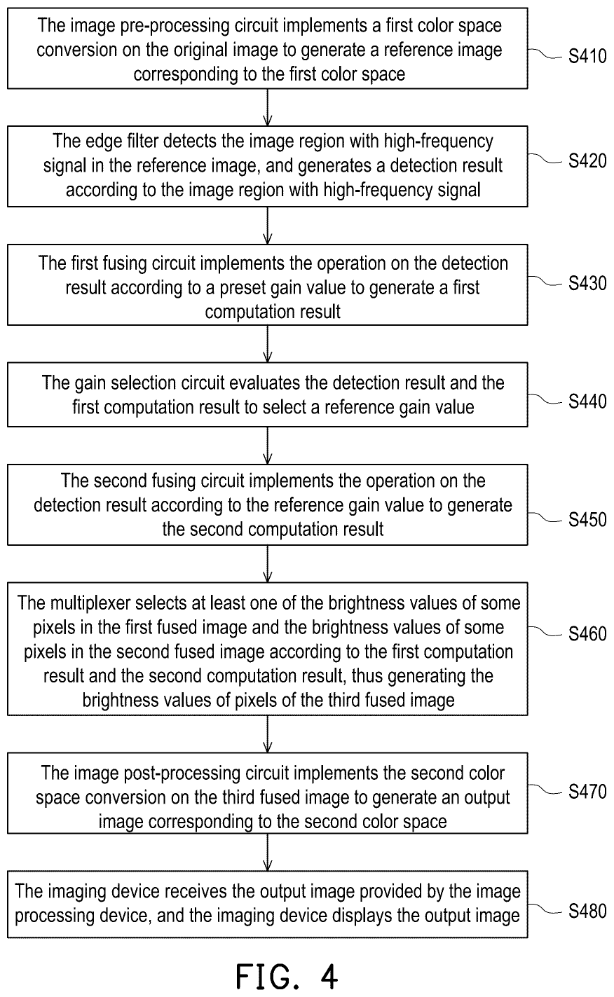

Please refer to FIG. 4, which is a flowchart of an image processing method illustrated according to an embodiment of this disclosure. The method of this embodiment may be executed by the image processing device 202 in FIG. 2. The details of each step in FIG. 4 will be explained below in conjunction with the components shown in FIG. 2 and FIG. 3.

In step S410, the image pre-processing circuit 310 performs a conversion of a first color space on the original image I1 to generate a reference image I2 corresponding to the first color space.

In an embodiment, the image pre-processing circuit 310 may perform image pre-processing on the original image I1, wherein the image pre-processing may include at least one of scaling, flipping, and conversion of the first color space, but is not limited thereto.

In an embodiment, the first color space may be, for example, YUV, HSL, HSV, YCrCb, or other color spaces, but is not limited thereto.

For ease of understanding, YUV serves as an example of the first color space in the following, but it is only used as an example and is not intended to limit the possible implementations of this disclosure.

In an embodiment, the original image I1 may be, for example, an RGB image (color image). Step S410 may be understood as the image pre-processing circuit 310 converting the RGB image to a YUV image, but is not limited thereto. More specifically, it may be known to those skilled in the art that the image pre-processing circuit 310 converts the R, G, B values corresponding to each pixel of the RGB image to the Y, U, V values corresponding to each pixel of the YUV image. The Y value is obtained, where the Y value represents a brightness value of a pixel of the original image I1.

In step S420, the edge filter 320 detects an image region with a high-frequency signal in the reference image I2, and generates a detection result R1 according to the image region with the high-frequency signal.

Generally, the high-frequency signal in an image refers to a rapidly changing signal received by a pixel, mainly including edges, textures, details, and possible noise. The signals are manifested as abrupt changes in brightness or color in the image, such as object contours, fine texture patterns, or random noise in the background. In frequency domain analysis, high-frequency signals correspond to high-frequency components, reflecting the richness of image details.

In an embodiment, the edge filter 320 includes at least one of a high-pass filter, a mean filter, a median filter, a Gaussian filter, a Laplacian filter, and a Sobel filter.

In an embodiment, the image region with a high-frequency signal may be, for example, an image region in the reference image I2 where a change in brightness value (e.g., contrast) is greater than a preset value. The preset value may be set by the designer. Enhancing the contrast of some reference pixels in the reference image I2 may enhance the sharpness of some regions of the reference image I2. The edge filter 320 is configured to detect the brightness value (Y value) corresponding to reference pixels in the reference image I2, obtain the positions of the reference pixels corresponding to the image region with the high-frequency signal, and generate the detection result R1. The detection result R1 is thus the position (coordinate) information of the reference pixels with the high-frequency signal in the reference image I2. The reference image I2 has W×H reference pixels, where W is the number of pixels in the horizontal direction of the reference image I2, and H is the number of pixels in the vertical direction of the reference image I2.

In step S430, in an embodiment, the first fusing circuit 330 receives the detection result R1 and the reference image I2 provided by the edge filter 320. The first fusing circuit 330 performs an operation on the detection result R1 according to a preset gain value G0 to generate a first computation result C1.

In an embodiment, the first fusing circuit 330 may amplify a brightness value of the reference pixel with the high-frequency signal in the detection result R1 by a magnification factor according to the preset gain value G0 to generate a first fused image M1. Then, the first fusing circuit 330 may generate the first computation result C1 according to the first fused image M1. Taking one pixel (first pixel) of the first fused image M1 as an example, the coordinate of the first pixel of the first fused image M1 is (2,2), the brightness value of the first pixel is F1, the coordinate of the reference pixel with the high-frequency signal in the reference image I2 in the detection result R1 is (2,2), and the brightness value of the reference pixel is L, wherein F1=K1*L, and K1 is the preset gain value G0. The coordinate of the first pixel of the first fused image M1 corresponds to the coordinate of the reference pixel with the high-frequency signal in the reference image I2. This disclosure adjusts the brightness values of some reference pixels (reference pixels with high-frequency signals) in the reference image I2 to form the first fused image M1. The first fusing circuit 330 generates the first computation result C1 according to the first fused image M1. The first computation result C1 includes the brightness values of various pixels (at least one first pixel) in the first fused image M1.

The first fusing circuit 330 provides the first computation result C1 to the gain selection circuit 340 and the multiplexer 360. The first fusing circuit 330 provides the first fused image M1 to the multiplexer 360.

In an embodiment, the display device 200 may provide a built-in and/or an external user interface that allows a user to set the preset gain value G0. In addition, the preset gain value G0 may also be a preset value pre-configured in the first fusing circuit 330, but is not limited thereto.

In step S440, the gain selection circuit 340 evaluates the detection result R1 and the first computation result C1 to select a reference gain value G1.

In an embodiment of this disclosure, the gain selection circuit 340 receives the reference image I2 and the detection result R1 provided by the edge filter 320, as well as the first computation result C1 provided by the first fusing circuit 330. The gain selection circuit 340 may provide a reference gain value G1. In an embodiment, the gain selection circuit 340 may determine whether a brightness value of at least one of the first pixels (hereinafter referred to as the first specific pixel P1) in the first fused image M1 of the first computation result C1 is greater than a first threshold.

In an embodiment, in response to determining that the brightness value of the first specific pixel P1 is greater than the first threshold, the gain selection circuit 340 selects a first gain value as the reference gain value G1 corresponding to the first specific pixel P1. On the other hand, in response to determining that the brightness value of the first specific pixel P1 is not greater than the first threshold, the gain selection circuit 340 selects a second gain value as the reference gain value G1 corresponding to the first specific pixel P1, wherein the second gain value is greater than the first gain value. In an embodiment, the second gain value is the preset gain value G0.

In other words, for each first pixel of the first fused image M1 of the first computation result C1, the gain selection circuit 340 may select the first gain value as the corresponding reference gain value G1 when determining that the brightness value of the first pixel is greater than the first threshold, and may select the second gain value as the corresponding reference gain value G1 when determining that the brightness value of the first pixel is not greater than the first threshold.

In an embodiment, both the first gain value and the second gain value are constant values.

In other embodiments, the gain selection circuit 340 may select values suitable as the first gain value and the second gain value from within a gain range. Furthermore, in an embodiment, the upper limit value of the gain range may be, for example, the preset gain value G0.

In an embodiment, both the first gain value and the second gain value are constant values.

In an embodiment, when the brightness value of the first specific pixel P1 is greater than the first threshold, the first gain value may be negatively correlated with a first difference value between the brightness value of the first specific pixel P1 and the first threshold. That is, in the case where the brightness value of the first specific pixel P1 is greater than the first threshold, the smaller the brightness value of the first specific pixel P1, the larger the first gain value; the larger the brightness value of the first specific pixel P1, the smaller the first gain value.

Furthermore, the brightness value of the first specific pixel P1 being greater than the first threshold indicates that the position of the reference pixel of the first specific pixel P1 in the detection result R1 may have a ringing effect. Therefore, the gain selection circuit 340 selects a smaller value from within the gain range as the first gain value to reduce the ringing effect.

Moreover, when the brightness value of the first specific pixel P1 is not greater than the first threshold, the second gain value may be positively correlated with a second difference value between the brightness value of the first specific pixel P1 and the first threshold. That is, in the case where the brightness value of the first specific pixel P1 is not greater than the first threshold, the second gain value is smaller when the smaller the brightness value of the first specific pixel P1 is smaller; the second gain value is larger when the brightness value of the first specific pixel P1 is larger.

Furthermore, the brightness value of the first specific pixel P1 being not greater than the first threshold indicates that the position of the reference pixel of the first specific pixel P1 in the detection result R1 may not have a ringing effect. Therefore, the gain selection circuit 340 may select a larger value from within the gain range as the second gain value to increase the corresponding sharpness.

In an embodiment, a lower limit value of the gain range may be set as a constant value by the designer according to requirements.

In another embodiment, the lower limit value of the gain range may be determined through specific means. For example, the designer may gradually increase the gain value and use this gain value to amplify the brightness values of reference pixels in the detection result R1 to generate a test result image. When the designer observes the appearance of white edges (indicating ringing effect) in the test result image, the designer may then gradually decrease the gain value and continue to observe the corresponding test result image. When the white edges in the test result image disappear, the gain value may be determined as the lower limit value of the gain range. The method is not limited thereto.

In step S450, the second fusing circuit 350 performs an operation on the detection result R1 according to the reference gain value G1 to generate a second computation result C2.

In an embodiment, the second fusing circuit 350 receives the reference gain value G1 provided by the gain selection circuit 340, the detection result R1, and the reference image I2. The second fusing circuit 350 amplifies a brightness value of the reference pixel with the high-frequency signal in the detection result R1 according to the reference gain value G1 to generate a second fused image M2. Subsequently, the second fusing circuit 350 may generate the second computation result C2 based on the second fused image M2.

Taking one pixel (second pixel) of the second fused image M2 as an example, the coordinate of the second pixel of the second fused image M2 is (2,2), the brightness value of the second pixel is F2, the coordinate of the reference pixel with the high-frequency signal in the reference image I2 of the detection result R1 is (2,2), and the brightness value of the reference pixel is L, wherein F2=K2*L, and K2 is the reference gain value G1. The coordinate of the second pixel of the second fused image M2 corresponds to the coordinate of the reference pixel with the high-frequency signal in the reference image I2. In this disclosure, the brightness values of some reference pixels (reference pixels with high-frequency signals) of the reference image I2 are adjusted to form the second fused image M2. The second fusing circuit 350 generates the second computation result C2 based on the second fused image M2. The second computation result C2 includes the brightness values of various pixels (at least one second pixel) of the second fused image M2.

In step S460, the multiplexer 360 selects at least one of brightness values of some pixels (first pixels) in the first fused image M1 and brightness values of some pixels (second pixels) in the second fused image M2 according to the first computation result C1 and the second computation result C2, to generate brightness values of pixels (third pixels) of a third fused image M3.

In an embodiment of this disclosure, the multiplexer 360 receives the first fused image M1 and the first computation result C1 provided by the first fusing circuit 330, and receives the second fused image M2 and the second computation result C2 provided by the second fusing circuit 350.

In an embodiment, taking a single pixel as an example, the multiplexer 360 may determine whether a brightness value of the first pixel of the first fused image M1 is greater than a preset threshold (for example, 0×F0 (hexadecimal) or 11110000 (binary)).

In response to determining that the brightness value of the first pixel is greater than the preset threshold, the multiplexer 360 may select a brightness value of the second pixel of the second fused image M2 as a brightness value of a third pixel of the third fused image M3. The position (coordinate) of the second pixel is equal to the position (coordinate) of the third pixel.

On the other hand, in response to determining that the brightness value of the first pixel is not greater than the preset threshold, the multiplexer 360 may select a brightness value of the first pixel of the first fused image M1 as a brightness value of a third pixel of the third fused image M3. The position (coordinate) of the first pixel is equal to the position (coordinate) of the third pixel.

In an embodiment, the multiplexer 360 may select brightness values of all pixels (first pixels) in the first fused image M1 according to the first computation result C1 and the second computation result C2, to generate brightness values of all pixels (third pixels) of the third fused image M3.

In an embodiment, the multiplexer 360 may select brightness values of all pixels (second pixels) in the second fused image M2 according to the first computation result C1 and the second computation result C2, to generate brightness values of all pixels (third pixels) of the third fused image M3.

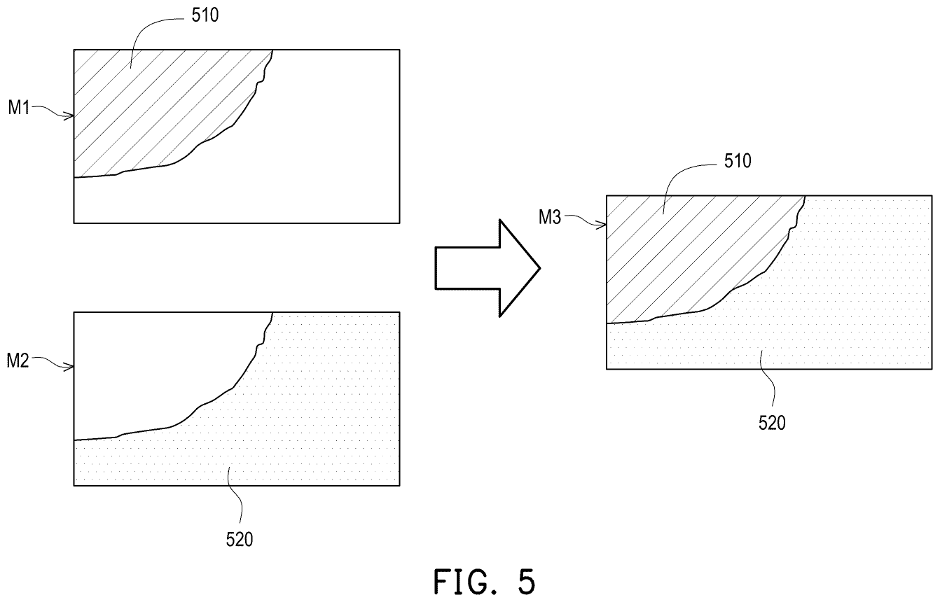

Please refer to FIG. 5, which is a schematic diagram illustrating the generation of the third fused image M3 according to an embodiment of this disclosure. In FIG. 5, the brightness value of the first pixel of the slashed region 510 of the first fused image M1 is not greater than the preset threshold, the first pixel of the slashed region 510 may form the third pixel of the corresponding slashed region 510 of the third fused image M3, where the brightness value of the third pixel is equal to the brightness value of the first pixel of the slashed region 510.

In addition, for a first pixel not located in the slashed region 510 (whose brightness value is, for example, greater than the preset threshold), the multiplexer 360 may find the position of a second pixel (for example, the second pixel of the dotted region 520) in the second fused image M2 corresponding to the position of the first pixel not located in the slashed region 510, and the second pixel of the dotted region 520 may form the third pixel of the corresponding dotted region 520 of the third fused image M3, where the brightness value of the third pixel is equal to the brightness value of the second pixel of the dotted region 520.

In step S470, the image post-processing circuit 370 performs a conversion of a second color space on the third fused image M3 to generate an output image I3 corresponding to the second color space.

In an embodiment, when the image post-processing circuit 370 receives the third fused image M3 provided by the multiplexer 360, the image post-processing circuit 370 may perform image post-processing on the third fused image M3, wherein the image post-processing includes at least one of conversion of the second color space, brightness adjustment, and color quantization.

In an embodiment, the second color space may be, for example, the color space corresponding to the original image I1, such as the RGB color space, but is not limited thereto. In this case, the output image I3 may be, for example, another RGB image converted from the YUV image corresponding to the third fused image M3, but is not limited thereto.

In step S480, the imaging device 204 receives the output image I3 provided by the image processing device 202, and the imaging device 204 displays the output image I3. In an embodiment where the imaging device 204 is an optical engine, the imaging device 204 may, for example, project the output image I3 onto a projection plane (such as a screen and/or wall), but is not limited thereto.

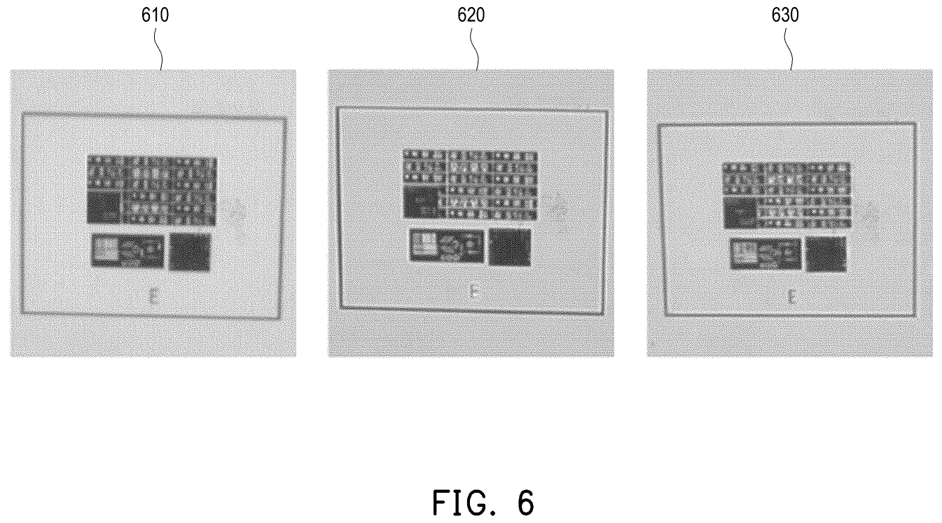

Please refer to FIG. 6, which is a diagram illustrating an image processing effect according to an embodiment of this disclosure.

In this embodiment, the images 610, 620, and 630 are, for example, output images I3 respectively projected onto a projection plane. In the context of FIG. 6, the image 610 is, for example, an original image, the image 620 is, for example, a result image obtained by processing the image 610 using an existing technique (e.g., using a high-pass filter), and the image 630 is, for example, an output image obtained by processing the image 610 using the method proposed in the embodiment of this disclosure.

As can be seen from FIG. 6, the image 610, without being processed by a high-pass filter, has relatively blurred edges. However, after the image 610 is processed by a high-pass filter to obtain the image 620, although the edge portions become clearer, the ringing effect becomes more obvious.

In contrast, after the image 610 is processed using the method disclosed in this disclosure to obtain the image 630, not only is the clarity improved, but the ringing effect is also suppressed.

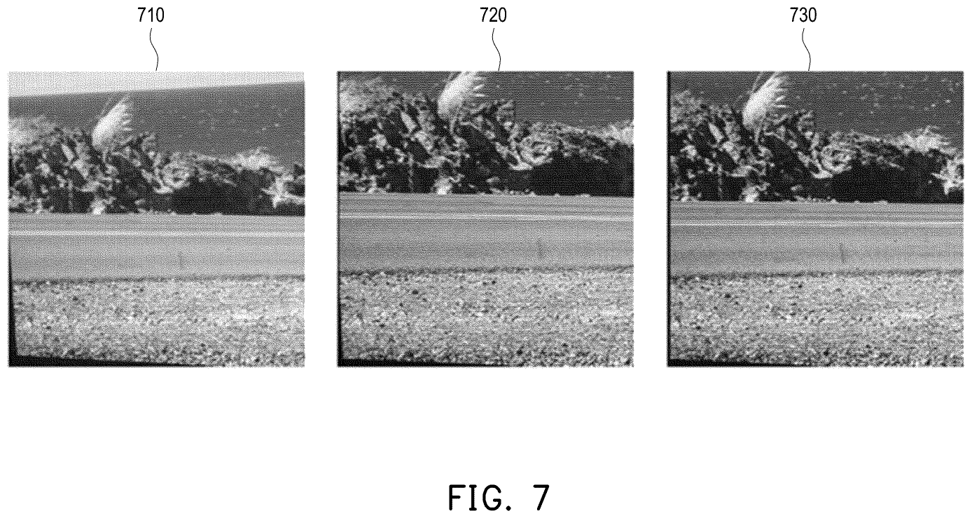

Please refer to FIG. 7, which is a diagram illustrating an image processing effect according to an embodiment of this disclosure.

In this embodiment, the images 710, 720, and 730 are, for example, output images I3 respectively projected onto a projection plane. In the context of FIG. 7, the image 710 is, for example, the original image under consideration, the image 720 is, for example, a result image obtained by processing the image 710 using an existing technique (e.g., using a high-pass filter), and the image 730 is, for example, an output image obtained by processing the image 710 using the method proposed in the embodiment of this disclosure.

As can be seen from FIG. 7, in the image 710, without being processed by a high-pass filter, the grains of sand on the ground are relatively blurred. However, after the image 710 is processed by a high-pass filter to obtain the image 720, although the grains of sand on the ground become clearer, the ringing effect becomes more obvious.

In contrast, after the image 710 is processed using the method of this disclosure to obtain the image 730, not only is the clarity improved, but the ringing effect is also suppressed.

In summary, the image processing method and display device of the embodiments of this disclosure have at least one of the following advantages: since the embodiments of this disclosure may select the gain value for magnifying pixel brightness values in a more flexibly adjustable way, it is possible to maintain the clarity of the output image while reducing the impact of the ringing effect on the output image.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. An image processing method, comprising:
performing, by an image pre-processing circuit, a conversion of a first color space on an original image to generate a reference image corresponding to the first color space;
detecting, by an edge filter, an image region with a high-frequency signal in the reference image to generate a detection result;
performing, by a first fusing circuit, an operation on the detection result based on a preset gain value to generate a first computation result;
evaluating, by a gain selection circuit, the detection result and the first computation result to select a reference gain value;
performing, by a second fusing circuit, an operation on the detection result based on the reference gain value to generate a second computation result;
selecting, by a multiplexer and based on the first computation result and the second computation result, at least one of brightness values of a first pixel of a first fused image and a second pixel of a second fused image to generate a brightness value of a pixel of a third fused image; and
performing, by an image post-processing circuit, a conversion of a second color space on the third fused image to generate an output image corresponding to the second color space.

2. The method as claimed in claim 1, wherein the edge filter comprises at least one of a high-pass filter, a mean filter, a median filter, a Gaussian filter, a Laplacian filter, and a Sobel filter.

3. The method as claimed in claim 1, wherein the image region with the high-frequency signal is an image region where a change in a brightness value in the reference image is greater than a preset value.

4. The method as claimed in claim 1, further comprising: detecting, by the edge filter, brightness values of reference pixels in the reference image to obtain positions of the reference pixels corresponding to the image region with the high-frequency signal to generate the detection result.

5. The method as claimed in claim 4, further comprising: magnifying, by the first fusing circuit and according to the preset gain value, a brightness value of the reference pixel with the high-frequency signal in the detection result by a magnification factor to generate a first fused image; and generating, by the first fusing circuit, a first computation result according to the first fused image.

6. The method as claimed in claim 5, further comprising: determining, by the gain selection circuit, whether a brightness value of at least one of first pixels in the first fused image of the first computation result is greater than a first threshold.

7. The method as claimed in claim 6, further comprising, in response to determining that the brightness value of a first specific pixel is greater than the first threshold, selecting, by the gain selection circuit, a first gain value as a reference gain value corresponding to the first specific pixel, wherein the first specific pixel is at least one of the first pixels.

8. The method as claimed in claim 7, further comprising: in response to determining that the brightness value of the first specific pixel is not greater than the first threshold, selecting, by the gain selection circuit, a second gain value as the reference gain value corresponding to the first specific pixel, wherein the second gain value is greater than the first gain value.

9. The method as claimed in claim 8, further comprising: magnifying, by the second fusing circuit and according to the reference gain value, the brightness value of the reference pixel with the high-frequency signal in the detection result by the magnification factor to generate the second fused image; and generating, by the second fusing circuit, the second computation result according to the second fused image.

10. The method as claimed in claim 9, further comprising determining, by the multiplexer, whether the brightness value of the first pixel of the first fused image is greater than a preset threshold.

11. The method as claimed in claim 10, further comprising, in response to determining that the brightness value of the first pixel is greater than the preset threshold, selecting, by the multiplexer, a brightness value of the second pixel of the second fused image as a brightness value of a third pixel of the third fused image.

12. The method as claimed in claim 11, further comprising, in response to determining that the brightness value of the first pixel is not greater than the preset threshold, selecting, by the multiplexer, the brightness value of the first pixel of the first fused image as a brightness value of the third pixel of the third fused image.

13. A display device, comprising:
an image processing device, comprising:
an image pre-processing circuit, configured to perform a conversion of a first color space on an original image to generate a reference image corresponding to the first color space;
an edge filter, electrically connected to the image pre-processing circuit and configured to detect an image region with a high-frequency signal in the reference image to generate a detection result;
a first fusing circuit, electrically connected to the edge filter and configured to perform an operation on the detection result with a preset gain value to generate a first computation result;
a gain selection circuit, electrically connected to the edge filter and configured to evaluate the detection result and the first computation result to select a reference gain value;
a second fusing circuit, electrically connected to the gain selection circuit and configured to perform an operation on the detection result according to the reference gain value to generate a second computation result;
a multiplexer, electrically connected to the first fusing circuit and the second fusing circuit and configured to select at least one of brightness values of a first pixel of a first fused image and a second pixel of a second fused image according to the first computation result and the second computation result to generate a brightness value of a pixel of a third fused image; and
an image post-processing circuit, electrically connected to the multiplexer and configured to perform a conversion of a second color space on the third fused image to generate an output image corresponding to the second color space; and
an imaging device, electrically connected to the image processing device and configured to receive the output image and display the output image.

14. The display device as claimed in claim 13, wherein the edge filter comprises at least one of a high-pass filter, a mean filter, a median filter, a Gaussian filter, a Laplacian filter, and a Sobel filter.

15. The display device as claimed in claim 13, wherein the image region with the high-frequency signal is an image region where a change in a brightness value in the reference image is greater than a preset value.

16. The display device as claimed in claim 13, wherein the edge filter is configured to detect brightness values of reference pixels in the reference image to obtain positions of the reference pixels corresponding to the image region with the high-frequency signal to generate the detection result.

17. The display device as claimed in claim 16, wherein the first fusing circuit is configured to magnify the brightness value of the reference pixel with the high-frequency signal in the detection result by a magnification factor according to the preset gain value to generate the first fused image; and the first fusing circuit is configured to generate the first computation result according to the first fused image.

18. The display device as claimed in claim 17, wherein the gain selection circuit is configured to determine whether a brightness value of at least one of first pixels in the first fused image of the first computation result is greater than a first threshold.

19. The display device as claimed in claim 18, wherein, in response to determining that a brightness value of a first specific pixel is greater than the first threshold, the gain selection circuit is configured to select a first gain value as a reference gain value corresponding to the first specific pixel, wherein the first specific pixel is at least one of the first pixels.

20. The display device as claimed in claim 19, wherein, in response to determining that the brightness value of the first specific pixel is not greater than the first threshold, the gain selection circuit is configured to select a second gain value as the reference gain value corresponding to the first specific pixel, wherein the second gain value is greater than the first gain value.

21. The display device as claimed in claim 20, wherein the second fusing circuit is configured to magnify the brightness value of the reference pixel with the high-frequency signal in the detection result by the magnification factor according to the reference gain value to generate a second fused image; and the second fusing circuit is configured to generate the second computation result according to the second fused image.

22. The display device as claimed in claim 21, wherein the multiplexer is configured to determine whether the brightness value of the first pixel of the first fused image is greater than a preset threshold.

23. The display device as claimed in claim 22, wherein, in response to determining that the brightness value of the first pixel is greater than the preset threshold, the multiplexer is configured to select a brightness value of the second pixel of the second fused image as a brightness value of a third pixel of the third fused image.

24. The display device as claimed in claim 23, wherein, in response to determining that the brightness value of the first pixel is not greater than the preset threshold, the multiplexer is configured to select the brightness value of the first pixel of the first fused image as the brightness value of the third pixel of the third fused image.
